(19) United States
(12) Patent Application Publication
(10) Pub. No.: US 2010/0247187 A1
(43) Pub. Date: Sep. 30, 2010

(54) IMAGE FORMING APPARATUS AND IMAGE FORMING METHOD

(75) Inventors: Masahiro MAEDA, Matsumoto-shi (JP); Yoichi YAMADA, Shiojiri-shi (JP); Masaru KOBASHI, Matsumoto-shi (JP); Tomohiro ARUGA, Matsumoto-shi (JP); Takatomo FUKUMOTO, Shiojiri-shi (JP); Atsunori KITAZAWA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/727,678

(22) Filed: Mar. 19, 2010

(30) Foreign Application Priority Data
Mar. 26, 2009 (JP) 2009-077269

(51) Int. Cl. G03G 21/10

(52) U.S. Cl. 399/346; 399/350

(57) ABSTRACT

An image forming apparatus includes: a latent image carrier which circumferentially rotates in a predetermined rotational direction; a lubricant applying unit which applies a lubricant on a surface of the latent image carrier in a predetermined application position; a developing unit which adheres a toner including an additive having an abrasion effect onto the surface of the latent image carrier on which the lubricant is coated to form a toner image, in a development position located on a downstream side of the application position in the rotational direction; and a conductive blade which cleans and removes the toner on the surface of the latent image carrier in contact with the surface of the latent image carrier, and charges the surface of the latent image carrier, in a cleaning and charging position located on an upstream side of the development position in the rotational direction.

### BACKGROUND

1. Technical Field

The present invention relates to an image forming apparatus and an image forming method in which a toner image is formed by developing an electrostatic latent image formed on a surface of a latent image carrier using a toner, and more specifically, to cleaning and charging the surface of the latent image carrier.

2. Related Art

An image forming apparatus and a method thereof are known in the related art, in which a toner image is formed by developing an electrostatic latent image formed on a surface of a latent image carrier which circumferentially rotates in a predetermined rotational direction using a toner, and is transferred to a transfer medium. In the image forming apparatus and the method thereof, since the efficiency of the transfer from the latent image carrier to the transfer medium is 100% or less, a small amount of toner may remain on the surface of the latent image carrier after transfer. In such an image forming apparatus, a so-called blade type cleaning unit, in which the remaining toner is removed by bringing a cleaning blade into contact with the surface of the latent image carrier in a cleaning position located on a downstream side of a transfer position in the rotational direction of the latent image carrier, is widely used.

However, recently, in order to achieve high-definition image, high speed processing and low temperature fixing, there have been attempts to use a toner having a particle diameter smaller than before (for example, having a volume average particle diameter of 5 μm or less and a degree of circularity of 0.95 or more). This small particle diameter toner escapes from the cleaning blade, and thus, it is difficult to remove the remaining toner from the latent image carrier. Further, a filming layer is gradually formed on the surface of the latent image carrier by the remaining toner, to thereby decrease the transfer efficiency and to increase a friction coefficient of the cleaning blade and the latent image carrier, thereby leading to problems such as damage to the latent image carrier.

Accordingly, for example, in an apparatus disclosed in JP-A-2007-86262 (FIG. 1), a lubricant is applied to a surface of a photosensitive body to solve the above problem. That is, solidified zinc stearate (lubricant) is scraped by the contact of an application brush, and then, the scraped zinc stearate is applied on the surface of the photosensitive body by the application brush. Thus, a lubricant layer is formed on the surface of the photosensitive body as a protection film of the photosensitive body. Thus, even in the case that image forming is performed using a toner having a small particle diameter, the small particle diameter toner may be reliably cleaning-removed from the surface of the photosensitive body by a cleaning blade. Thus, the surface of the photosensitive body from which the toner is cleaning-removed by the cleaning blade is charged at a predetermined surface electric potential by a charging member that is arranged on a downstream side of a cleaning position.

However, in view of the miniaturization of the apparatus and reduction in the number of components, it is conceivable to apply a technology disclosed in JP-A-4-304476 (FIGS. 2 and 5), that is, a technology in which a cleaning blade has a charging function and a cleaning function to the apparatus disclosed in JP-A-2007-86262 (FIG. 1). However, in an image forming apparatus with such a combination, a charging bias is applied to the cleaning blade to charge a surface of a latent image carrier such as a photosensitive drum or a photosensitive belt. Further, load is applied to press the cleaning blade against the surface of the latent image carrier. Due to such a charging bias or load, a toner is adhered to a ridge line portion (a numeral 4a in FIG. 1 which will be described later) of a front end part of the cleaning blade which is in contact with the surface of the latent image carrier, and further, the adherence of the toner is increased due to the zinc stearate (lubricant). Thus, even though the filming layer is prevented from being formed on the surface of the latent image carrier by using the above described lubricant, the toner is adhered on the front end part of the cleaning blade, and thus, the charging becomes unstable and image deterioration occurs due to the cleaning deterioration.

### SUMMARY

An advantage of some aspects of the invention is that it provides an image forming apparatus and an image forming method in which a charging process and a cleaning process on a surface of a latent image carrier can be desirably performed with a small number of components.

According to an aspect of the invention, there is provided an image forming apparatus including: a latent image carrier which circumferentially rotates in a predetermined rotational direction; a lubricant applying unit which applies a lubricant on a surface of the latent image carrier in a predetermined application position; a developing unit which adheres a toner including an additive having an abrasion effect onto the surface of the latent image carrier on which the lubricant is applied to form a toner image, in a development position located on a downstream side of the application position in the rotational direction; and a conductive blade which cleans and removes the toner on the surface of the latent image carrier by being in contact with the surface of the latent image carrier, and charges the surface of the latent image carrier, in a cleaning and charging position located on an upstream side of the development position in the rotational direction.

According to another aspect of the invention, there is provided an image forming method including: applying a lubricant on a surface of a latent image carrier which circumferentially rotates in a predetermined rotational direction; adhering a toner onto the surface of the latent image carrier on which the lubricant is applied to form a toner image; and transferring the toner image onto a transfer medium; cleaning and removing remaining transfer toner which remains on the surface of the latent image carrier by bringing a conductive blade into contact with the surface of the latent image carrier, and charging the surface of the latent image carrier. As the toner, a toner including an additive having an abrasion effect is used.

In the image forming apparatus and the image forming method with such a configuration, the cleaning of the surface of the latent image carrier is performed by the conductive blade which is in contact with the surface of the latent image carrier in the cleaning and charging position. Further, at the same time, the surface of the latent image carrier is charged by the conductive blade. Since the conductive blade has the charging function and the cleaning function as described above, the charging process and the cleaning process can be performed with a small number of components.

In addition, if the toner is adhered to a ridge line portion in which the conductive blade is in contact with the latent image carrier, a charging characteristic or cleaning ability is deteriorated. Moreover, in the invention, since the lubricant is applied to the surface of the latent image carrier, adherence of the toner to the ridge line portion tends to be increased by the lubricant. However, since the toner includes the additive having the abrasion effect, the toner or lubricant adhered to the ridge line portion of the conductive blade is abraded by the additive, thereby controlling increase of the adhered toner. Thus, it is possible to achieve a desired charging process and cleaning process of the surface of the latent image carrier over a long period of time. Herein, the additive having such an abrasion effect may employ, for example, strontium titanate.

Herein, a position relation of the cleaning and charging position and the application position is arbitrary, but it is desirable that the cleaning and charging position is located on a downstream side of the application position in the rotational direction. With such an arrangement relation, the lubricant which is applied to the surface of the latent image carrier by the lubricant applying unit is uniformized by the conductive blade, and thus, uniform lubricant film can be formed on the surface of the latent image carrier.

Further, the charging process for the surface of the latent image carrier may employ a single stage of charging by the only conductive blade or two stages of charging by the conductive blade and the charger. In the latter case, the charger is arranged on a downstream side of the conductive blade in the rotational direction. Thus, the surface of the latent image carrier is charged at a first electric potential by the conductive blade in the cleaning and charging position, and then, the surface of the latent image carrier which is charged at the first electric potential is charged at a second electric potential by the charger in a secondary charging position. Thus, the surface of the latent image carrier can be more uniformly charged by using the two stages of charging as described above.

Moreover, as an example of the two stages of charging, the surface of the latent image carrier may be charged at the first electric potential having the same polarity as the normal charged polarity according to application of direct current voltage having the same polarity as the normal charged polarity of the toner by the conductive blade, and then, electric charges having reverse polarity to the normal charged polarity may be provided by the charger to adjust the electric potential of the surface of the latent image carrier to the second electric potential. Thus, the surface of the latent image carrier can be more uniformly charged.

In addition, in the single stage of charging, a configuration may be adopted in which the surface of the latent image carrier is charged according to application of a bias obtained by overlapping alternating current voltage and direct current voltage having the same polarity with the normal charging polarity of the toner by the conductive blade. As described above, by overlapping the alternating current voltage with the direct current voltage, the surface of the latent image carrier can be more uniformly charged, compared with the single stage of charging case in which the only direct current voltage is applied to the conductive blade as a bias.

Moreover, the toner may include the additive having a leak function, thereby preventing reduction in the charging electric potential. That is, the charging in the cleaning and charging position becomes unstable while the cleaning and charging are repeated by the conductive blade, thereby causing problems such as reduction in the charging electric potential. However, if the toner includes the additive having the leak function, even though the toner is adhered to the conductive blade due to a long period of use, electric charges are provided to the surface of the latent image carrier through the leak additive, thereby desirably charging the surface of the latent image carrier. As a result, it is possible to achieve desirable image forming without a charging error over a long period of time. Titania, oxide semiconductor or inorganic particulates which are coated by a semiconductive film on at least part of a surface thereof may be used as the leak additive.

### BRIEF DESCRIPTION OF THE DRAWINGS

The invention will be described with reference to the accompanying drawings, wherein like numbers reference like elements.

FIGS. 1A and 1B schematically illustrate a main configuration of an embodiment of an image forming apparatus according to the invention.

FIG. 2 is a block diagram illustrating an electric configuration of the apparatus in FIG. 1.

FIG. 3 illustrates a relation between a blade applied voltage and a blade current of the apparatus in FIG. 1.

### DESCRIPTION OF EXEMPLARY EMBODIMENTS

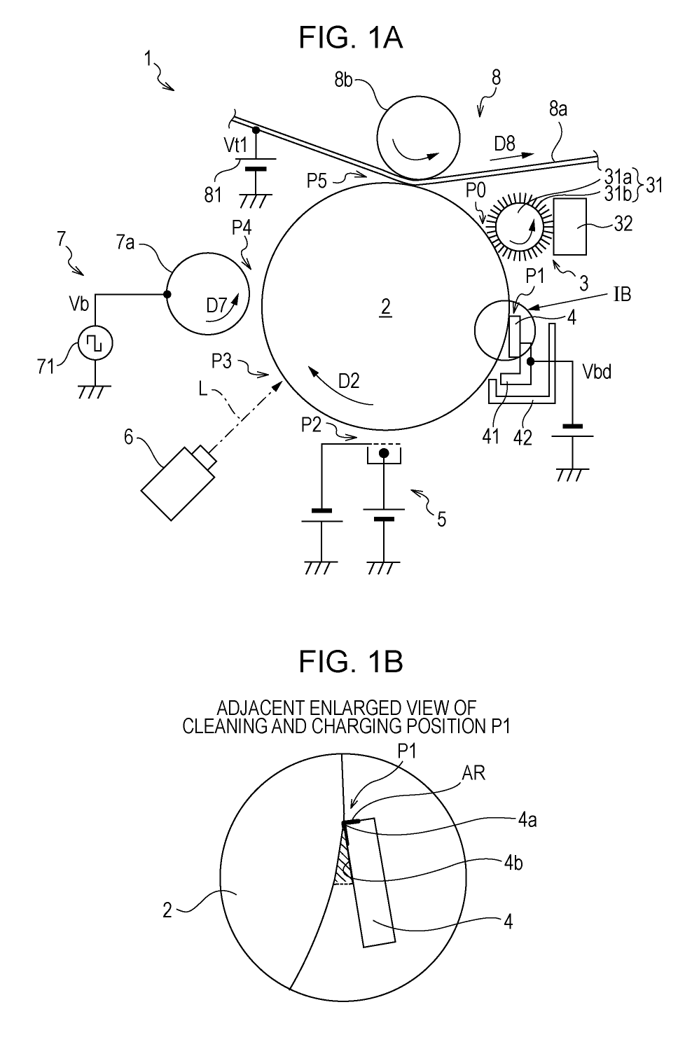

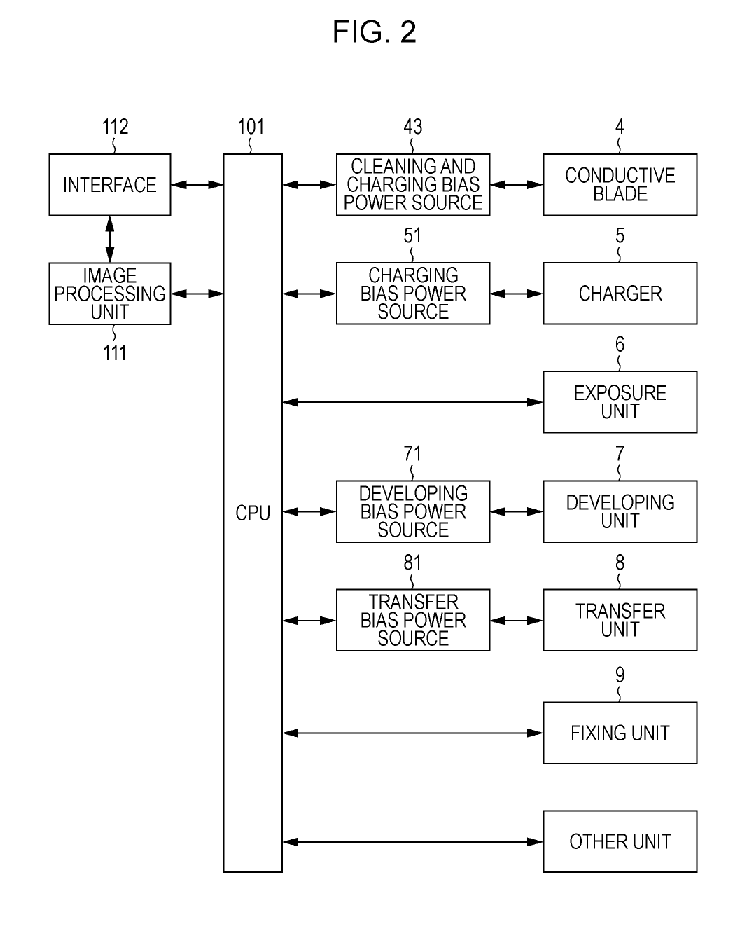

FIG. 1 schematically illustrates a main configuration of an embodiment of an image forming apparatus according to the invention. FIG. 2 is a block diagram illustrating an electric configuration of the apparatus in FIG. 1. In the image forming apparatus 1, an image is formed using a nonmagnetic one-component system negative charged toner. That is, in this embodiment, negative polarity is “normal charged polarity”. Alternatively, the image may be formed using a positive charged toner in which positive polarity is the normal charged polarity. Hereinafter, it is assumed that the image forming apparatus 1 uses a negative charged toner. However, in the case that the positive charged toner is used, a charging electric potential of each member to be described below may be set to reverse polarity. Herein, the toner includes a toner mother particle and an additive which is added to the toner mother particle, but in the following description, “toner” refers to all the particles made by adding the additive to the toner mother particle.

As shown in FIG. 1, the image forming apparatus 1 includes a photosensitive body 2 onto which an electrostatic latent image and a toner image are formed. The photosensitive body 2 is made of a photosensitive drum, and includes a cylindrical metal tube on a circumferential surface of which a photosensitive layer having a predetermined film thickness is formed, like a photosensitive drum which is known in the related art. For example, a conductive tube such as aluminum, etc. is used as the metal tube in the photosensitive body 2, and an organic photosensitive body which is known in the related art is used as the photosensitive layer. In such an embodiment, the photosensitive body 2 corresponds to a “latent image carrier” in the invention.

Around the photosensitive body 2, a lubricant applying unit 3 which applies a lubricant onto a surface of the photosensitive body 2, a conductive blade 4 which has a cleaning function and a primary charging function, a charger 5 which adjusts a surface electric potential of the photosensitive body 2 at a predetermined electric potential by performing a secondary charging process for the surface of the photosensitive body 2 which is primarily charged by the conductive blade 4, an exposure unit 6 which forms the electrostatic latent image by exposing the surface of the photosensitive body 2 according to an image signal, a developing unit 7 which develops the electrostatic latent image as a toner image, and a transfer unit 8 in which the toner image is transferred are sequentially arranged in a rotational direction D2 (clockwise in FIG. 1) of the photosensitive body 2, respectively. Hereinafter, a position in which the lubricant is applied by the lubricant applying unit 3 is defined as an application position P0; a position in which the conductive blade 4 and the surface of the photosensitive body 2 are in contact with each other to perform a cleaning and a primary charging is defined as a cleaning and charging position P1; a position in which a secondary charging is performed by the charger 5 is defined as a secondary charging position P2; a position in which a light beam L is illuminated from the exposure unit 6 to the surface of the photosensitive body 2 is defined as an exposure position P3; a position in which a developing roller 7a of the developing unit 7 is opposite to the photosensitive body 2 is defined as a development position P4; and a position in which the photosensitive body 2 is in contact with an intermediate transfer belt 8a is defined as a transfer position P5. In this embodiment, the respective positions are arranged in the above described order, from an upstream side of the rotational direction D2 of the photosensitive body 2 to a downstream side thereof.

In this embodiment, as the lubricant is applied to the surface of the photosensitive body 2 by the lubricant applying unit 3 as a “lubricant applying section” in the invention, two stages of charging are performed for the photosensitive body 2. That is, the surface of the photosensitive body 2 is primarily charged by the conductive blade 4, and then, is secondarily charged by the charger 5, thereby uniformly charging the surface of the photosensitive body 2 at a desirable electric potential. Configurations and operations of the lubricant applying unit 3, the conductive blade 4 and the charger 5 will be described later, which include a cleaning operation of remaining transfer toner.

On the surface of the photosensitive body 2 which is charged as described above, the electrostatic latent image is formed by the exposure unit 6. The exposure unit 6 exposes the surface of the photosensitive body 2 by the light beam L according to an image signal which is provided from an external apparatus, to form an electrostatic latent image corresponding to the image signal. More specifically, as shown in FIG. 2, if the image signal is provided through an interface 112 from the external apparatus such as a host computer which generates the image signal, a predetermined process is performed for the image signal by an image processing unit 111. The image signal is transmitted to the exposure unit 6 through a CPU 101 which controls the overall operation of the apparatus. The exposure unit 6 illuminates the light beam L on the surface of the photosensitive body 2 for exposing according to the image signal. A surface region of the photosensitive body 2 which is exposed (exposure region) is electrically neutralized, and is changed into a surface electric potential which is different from that of a surface region which is not exposed (non-exposure region). Thus, the electrostatic latent image corresponding to the image signal is formed on the photosensitive body 2. In this embodiment, the exposure unit 6 corresponds to a “latent image forming unit” in the invention.

A toner is supplied to the above described formed electrostatic latent image from the developing unit 7 and the electrostatic latent image is developed by the toner. The developing unit 7 of such an image forming apparatus 1 has a non-contact developing method in which the developing roller 7a is not in contact with the photosensitive body 2. The developing roller 7a is arranged opposite to the photosensitive body 2 with a predetermined gap, for example, 100 μm or more, and is rotated in an arrow direction D7 in FIG. 1. A predetermined developing bias Vb is applied to the developing roller 7a from a developing bias power source 71. In such an embodiment, the developing roller 7a corresponds to a “toner carrier” in the invention. Further, in this embodiment, in order to desirably perform the charging process and the cleaning process by the conductive blade 4, a toner including strontium titanate is used as the additive having an abrasion effect. Thus, effects obtained by the toner including the additive having the abrasion effect will be described later.

The transfer unit 8 includes the intermediate transfer belt 8a which is an endless belt capable of carrying the toner image on a surface thereof and circumferentially rotates in an arrow direction D8 in FIG. 1. The intermediate transfer belt 8a is brought in contact with the surface of the photosensitive body 2 by a back up roller 8b which is arranged adjacent to the photosensitive body 2. In addition, a transfer bias Vt1 having reverse polarity to the charged polarity of the toner is applied to the intermediate transfer belt 8a from a transfer bias power source 81, and thus, the toner image which is developed on the photosensitive body 2 is transferred to the intermediate transfer belt 8a (primary transfer). The toner image which is transferred to the intermediate transfer belt 8a is secondarily transferred onto a recording paper (not shown) and permanently fixed on the recording paper by a fixing unit 9 for output.

In the rotational direction D2 of the photosensitive body 2, the lubricant applying unit 3 is arranged in the application position P0 located on a downstream side of the transfer position P5. The lubricant applying unit 3 includes an application brush roller 31 and a lubricant bar 32 which is formed by solidifying the lubricant in a solid form. The application brush roller 31 includes a roller body 31a which is rotatably installed and a plurality of brush hairs 31b which are planted on a circumferential surface of the roller body 31a. The brush hairs 31b may employ brush hairs having, for example, protonema resistance of 2.0×10⁸ Ωcm which are made of nylon having a purity of 6D (denir) (corresponding to Model No. UUN (6 nylon, carbon type, uniform dispersion type) made by TOEISANYO CO., LTD.), and brush density of 120 KF/inch².

Further, in a state that the application brush roller 31 is arranged opposite to the photosensitive body 2 so that the brush hairs 31b are in contact with the surface of the photosensitive body 2, the roller body 31a rotates in a forward rotation with respect to the rotation of the photosensitive body 2 (a direction in which a tangential direction of speed of the rotation of the photosensitive body 2 and a tangential direction of speed of the rotation of the brush hairs 31b are the same in a contact position of the photosensitive body 2 and the brush hairs 31b), that is, so-called with rotation.

Further, the lubricant bar 32 is arranged opposite (right side in FIG. 1) the photosensitive body 2 with the application brush roller 31 being interposed therebetween. The brush hairs 31b of the application brush roller 31 which rotates as described above are in contact with the lubricant bar 32 to scrape the lubricant bar 32, and the scraped lubricant is transferred on the surface of the photosensitive body 2 to apply the surface of the photosensitive body 2. Thus, the lubricant is applied on the surface of the photosensitive body 2 in the application position P0, thereby forming a lubricant layer on the surface of the photosensitive body 2. The lubricant may employ, for example, fatty acid metallic salt, or a powder lubricant in addition to the above described solid lubricant. Herein, in order to prevent a problem such as scattering, it is desirable to use solid lubricant. In addition, metallic salt which forms the fatty acid metallic salt may employ, for example, zinc, lithium, natrium, magnesium, aluminum, lead, nickel or the like. Moreover, the fatty acid which forms the fatty acid metallic salt may employ, for example, stearic acid, lauric acid, palmitic acid or the like. Herein, in the case of the solid lubricant, zinc stearate may be preferably used.

Further, the conductive blade 4 is arranged in the cleaning and charging position P1 located on a downstream side of the application position P0 in the rotational direction D2. The conductive blade 4 may use rubber, resin or the like having a conductive characteristic to perform the cleaning process of the photosensitive body 2 as in the related art. Moreover, in this embodiment, the conductive blade 4 has a plate shape which is extended in a width direction (direction perpendicular to a plane of FIG. 1), and the length of the width direction is slightly longer than the width of an image forming region of the photosensitive body 2. For example, if the length of the width direction of the image forming region is 291 mm, the length of the width direction of the conductive blade 4 may be set to 310 mm.

A rear end part of the conductive blade 4 is supported by a support member 41 which is formed of metal material (including alloy) such as stainless steel, iron, copper, aluminum, aluminum alloy, nickel or phosphor bronze, or material having a conductive characteristic obtained by depositing conductive metal such as aluminum to conductive resin, resin or the like. Meanwhile, a front end part of the conductive blade 4 protrudes from a front end of the support member 41 and is in contact with the surface of the photosensitive body 2 in the cleaning and charging position P1. In this embodiment, the front end part of the conductive blade 4 is in contact with the photosensitive body 2 in a reverse direction to the rotational direction D2 of the photosensitive body 2, and a contact angle (inclined angle of the conductive blade 4 in a tangential direction to the surface of the photosensitive body 2 in the cleaning and charging position P1) of the conductive blade 4 is set to about 10°. Further, in this embodiment, the weight of the conductive blade 4 against the photosensitive body 2 is set to 13 g/cm. Under such a cleaning condition, the remaining toner on the surface of the photosensitive body 2 is scraped by the conductive blade 4, thereby to be cleaning-removed from the surface of the photosensitive body 2. The scraped toner is collected in a toner collecting box 42 which is arranged in a position downward from the conductive blade 4 and the support member 41.

In addition, a cleaning and charging bias power source 43 is electrically connected to the conductive blade 4, and a cleaning and charging bias Vbd having negative direct current (DC) is applied to the conductive blade 4. Thus, the surface of the photosensitive body 2 is charged at a negative electric potential. For example, if the cleaning and charging bias Vbd having the direct current of −1.4 kV is applied to a newly installed conductive blade 4, the surface electric potential of the photosensitive body 2 in the cleaning and charging position P1 may be charged at −600 V. That is, since a relation between the cleaning and charging bias Vbd and the surface electric potential (corresponding to “a first electric potential” in the invention) of the photosensitive body 2 in the cleaning and charging position P1 is varied according to the aging of the conductive blade 4, in this embodiment, a value of the cleaning and charging bias Vbd may be varied according to the aging of the conductive blade 4 as described later.

Since the surface electric potential of the photosensitive body 2 which is primarily charged as described above is uniformized, and the corresponding surface electric potential is secondarily charged at an electric potential (corresponding to “a second electric potential” in the invention) suitable for image forming, the charger 5 is installed in the secondary charging position P2 located on a downstream side of the cleaning and charging position P1, in the rotational direction D2 of the photosensitive body 2. In this embodiment, the charger 5 may employ a scorotron charger 5 which is well known in the related art, which is not in contact with the surface of the photosensitive body 2. The scorotron charger 5 is electrically connected to a charging bias power source 51. A positive wire-current Iw flows to a charge wire 5b of the scorotron charger 5, and a grid charging bias Vg having negative direct current (DC) is applied to a grid 5a. Accordingly, an electric charge having the reverse polarity (positive polarity) to the toner is provided to the photosensitive body 2 by the charger 5, and thus, the surface electric potential of the photosensitive body 2 becomes approximately uniform. Moreover, the surface electric potential of the photosensitive body 2 is adjusted to the second electric potential from the first electric potential, more specifically, to the surface electric potential which is set during the image forming. For example, if the direct current voltage of +4 Kv is applied to the charge wire 5b which is gold-coated to flow the wire current Iw of +400 μA and direct current voltage of −500 V is applied to the grid 5a, the surface electric potential of the photosensitive body 2 which is charged at −600 V by the primary charging is uniformly adjusted to approximately −500 V.

The above described exposure process and developing process are sequentially performed for the surface of the photosensitive body 2 which is charged at a desired second electric potential to form the toner image, and then, the toner image is transferred to the intermediate transfer belt (transfer medium) 8a by the transfer unit 8.

As described above, according to the embodiment, the toner is cleaning-removed from the surface of the photosensitive body 2 by the conductive blade 4. However, since part of a surface layer portion of the lubricant layer is scraped at that moment, as shown in an “enlarged view adjacent to the cleaning and charging position P1” in FIG. 1, the toner is adhered to a ridge line portion 4a of a front end part of the conductive blade 4 which is in contact with the surface of the photosensitive body 2, and the adherence of the toner is increased due to the zinc stearate (lubricant). The corresponding adherence component AR is indicated by a thick line shown in FIG. 1. If such an adherence component AR remains without being removed, the primary charging by the conductive blade 4 becomes unstable, or it is difficult to desirably perform the cleaning by the conductive blade 4, and thus, image quality deterioration occurs. However, since the toner used in the embodiment includes the additive having the abrasion effect, the toner or the lubricant which is adhered to the ridge line portion 4a of the conductive blade 4 is abraded by the additive, thereby reliably preventing increase of the adherence component AR. As a result, even though the image forming is continuously performed over a long period time, the primary charging process and the cleaning process of the photosensitive body 2 can be desirably performed by the conductive blade 4.

Further, in this embodiment, the toner is cleaning-removed from the surface of the photosensitive body 2 by the conductive blade 4 which is in contact with the surface of the photosensitive body 2 in the cleaning and charging position P1, and simultaneously, the surface of the photosensitive body 2 is primarily charged at the first electric potential. Since the primary charging process and the cleaning process are simultaneously performed by the conductive blade 4 as described above, the charging process and the cleaning process may be performed with a small number of components and miniaturization of the apparatus may be achieved.

In addition, in this embodiment, since the cleaning and charging position P1 is located on a downward side of the application position P0 in the rotational direction D2, the lubricant which is applied on the surface of the photosensitive body 2 by the lubricant application unit 3 is uniformized by the conductive blade 4, thereby forming a uniform lubricant film on the surface of the photosensitive body 2. Thus, deterioration of the photosensitive body 2 due to the lubricant or generation of discharging products may be prevented over the surface of the photosensitive body 2.

Further, the charging process for the surface of the photosensitive body 2 may be performed by a single stage of charging using only the conductive blade as in the apparatus disclosed in JP-A-4-304476 (FIGS. 2 and 5). However, in this embodiment, since two stages of charging processes are performed as described above, the following effects occur.

In the case of the single stage of charging, for example, as disclosed in the reference JP-A-4-304476 (FIGS. 2 and 5), a so-called overlap bias generated by overlapping alternating current voltage with direct current voltage is applied to the conductive blade 4. In this case, polarity or an electrical potential difference between the surface of the photosensitive body 2 and the conductive blade 4 rapidly varies. Further, due to the deterioration of the photosensitive body 2, there occur problems such as film thinning or cleaning ability deterioration. In addition, problems such as a cleaning error are generated by vibrations. However, in the embodiment, since the direct current voltage (blade applied voltage) having the same polarity as the normal charged polarity of the toner is provided to the conductive blade 4 to perform the primary charging of the surface of the photosensitive body 2, the primary charging process and the cleaning process can be desirably performed while preventing deterioration of the photosensitive body 2 and the cleaning error.

Further, the cleaning and charging bias power source 43 constant-voltage-controls the direct current voltage applied to the conductive blade 4 according to an operation command from the CPU 101, and thus, a so-called neutralization-free configuration, in which a neutralization unit is not installed, is employed. That is, in this embodiment, a surface region of the photosensitive body 2 which has passed through the transfer position P5 is configured to reach the cleaning and charging position P1 in a non-neutralized state. Accordingly, in the case that the corresponding surface region is the non-exposure region, the corresponding surface region does not receive illumination of the light beam L, and thus, the surface electric potential of the corresponding surface region remains as the electric potential (that is, the second electric potential) which is adjusted by the previously performed secondary charging process. Further, an electric potential difference between the corresponding non-exposure region and the conductive blade 4 is small and current flowing therebetween (blade current) is small as well. Accordingly, deterioration of the photosensitive body 2 or deterioration of the conductive blade 4 may be effectively prevented, thereby lengthening the life span of the apparatus. Especially, in the case of a black-and-white printing in which an average printing duty is low, that is, the non-exposure region is relatively wide, the above described effects are noticeable and effective. Thus, the invention may be effectively applied to the black-and-white image forming apparatus in which a single color printing is mainly performed.

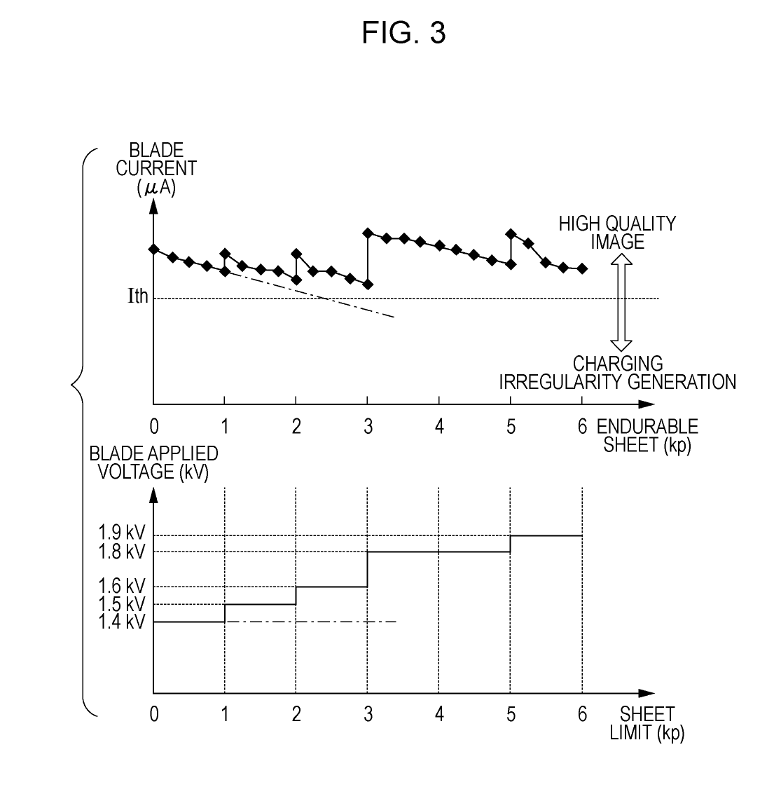

If aging of the conductive blade 4 occurs as the accumulated operation time or the number of accumulated printing sheets becomes increased, as shown in FIG. 3, charging irregularity may be generated. For example, it has been found out by experiment that if the printing sheets are accumulated in a state that the cleaning and charging bias Vbd of the direct current voltage of −1.4 kV is applied to the conductive blade 4, high quality images may be formed in a limit of about 2000 sheets or less; however, if the accumulated printing sheets exceed 2000, the blade current flowing between the conductive blade 4 and the photosensitive body 2 is decreased as indicated by a dashed-dotted line in FIG. 3, and the charging irregularity is generated on the surface of the photosensitive body 2, thereby deteriorating the image quality. That is, in order to desirably charge the surface of the photosensitive body 2, the blade current needs to be maintained at a predetermined value Ith (for example, 25 μA) or more. Accordingly, in this embodiment, whenever the number of the accumulated printing sheets becomes 1000, 2000, 3000 or 5000, the direct current voltage (blade applied voltage) to be applied to the conductive blade 4 is increased with a step shape. Thus, the blade current flowing between the conductive blade 4 and the surface of the photosensitive body 2 is constantly maintained at the predetermined value Ith or more, thereby desirably charging the surface of the photosensitive body 2. Accordingly, the surface of the photosensitive body 2 may be uniformly and desirably charged over a long period. In this embodiment, the aging of the conductive blade 4 is determined by the accumulated printing sheets, but a timing when the blade applied voltage is increased may be controlled on the basis of any other parameter, for example, accumulated operation time or the number of accumulated revolutions of the photosensitive body 2.

Further, in this embodiment, since the secondary charging is performed by the so-called scorotron charger 5 having positive polarity for the surface of the photosensitive body 2 which is primarily charged, relatively fewer discharging products or ozone are generated. In addition, the life span of the charge wire 5b may be lengthened. In the image forming apparatus 1 with such a configuration, it is not realistic to absolutely prevent discharging products from being generated. Thus, it is desirable to install an exhaust unit which exhausts surroundings of the cleaning and charging position P1 and the secondary charging position P2. Moreover, it is preferable to enhance exhausting efficiency of the discharging products from the cleaning and charging position P1 and the secondary charging position P2, by installing an airflow generating unit such as a fin which guides airflow in the cleaning and charging position P1 or the secondary charging position P2.

Further, in the image forming apparatus 1 which performs image forming using the above described small particle diameter toner, a part of the toner may escape from the conductive blade 4 to adhere to a blade surface 4b, and the toner is accumulated on the blade surface 4b while the cleaning and charging are repeated by the conductive blade 4, and thus, the primary charging becomes unstable in the cleansing and charging position P1, thereby causing a problem such as reduction in the charging electric potential. In order to solve the problems, it is preferable that the toner includes the additive having a leak function. That is, if the additive having the leak function (hereinafter, referred to as “leak additive”) is included in the toner which is adhered to the conductive blade 4 as described above, even though the toner is adhered on the conductive blade 4 due to a long period of use, an electric charge may be provided on the surface of the photosensitive body 2 through the leak additive, thereby desirably charging the surface of the photosensitive body 2. As a result, it is possible to achieve desirable image forming without charging error over a long period of time. Herein, by using the leak additive having a low isolation ratio, detachment of the leak additive from the toner may be prevented, and thus, the above described effect may be reliably achieved. In addition, an outer diameter of the leak additive may be set to be larger than that of an insulating additive included in the toner, and thus, the primary charging may be more stabilized. Titania, oxide semiconductor (zinc oxide, tin oxide or the like) or inorganic particulates such as silica which is coated by a semiconductive film such as ATO (obtained by doping antimony to tin oxide) or ITO (obtained by doping indium to tin oxide) on at least part of the surface may be used as the leak additive. Especially, zinc oxide is an example of the leak additive having a low isolation ratio.

In addition, since this embodiment employs the so-called non-contact developing method in which the toner is provided to the surface of the photosensitive body 2 from the developing roller (toner carrier) 7a which is arranged opposite to the photosensitive body 2 in a non-contact manner, to develop the electrostatic latent image, the following effects occur. That is, the additive detached from the toner inhibits the uniform charging of the surface of the photosensitive body 2. Thus, if the detached additive which is adhered to the developing roller 7a is scattered from the developing roller 7a to adhere to the photosensitive body 2, it is difficult to appropriately charge the surface of the photosensitive body 2, thereby causing deterioration of image quality. However, in this embodiment, since the developing roller 7a is spaced from the photosensitive body 2, it is difficult for the additive adhered to the developing roller 7a which is detached from the toner to be scattered to the photosensitive body 2, thereby preventing the above problems. Further, in order to effectively prevent the scattering of the additive detached from the developing roller 7a, for example, it is desirable that the developing roller 7a is formed of metal. This is because, with such a configuration, an image force of the additive for the developing roller 7a becomes large and squirting of the additive detached from the photosensitive body 2 becomes inhibited.

The invention is not limited to the above described embodiment, and may include a variety of modifications in addition to the above described embodiments without departing the spirit of the invention. For example, in this embodiment, the scorotron charger 5 having the positive polarity is used as the charger 5 which performs the secondary charging, but the charger 5 may employ other chargers such as a non-contact roller charger or a contact roller charger. That is, the charger 5 may employ a charger which is capable of adjusting the surface electric potential of the photosensitive body 2 to the second electric potential by providing the electric charge having the reverse polarity to the normal charged polarity to the surface of the photosensitive body 2 which is primarily charged.

Further, in this embodiment, the direct current voltage to be applied to the conductive blade 4 is constant-voltage-controlled, but the blade current flowing between the conductive blade 4 and the photosensitive body 2 may be constant-current-controlled. Herein, in the case that the constant current control is performed, a predetermined current flows between the non-exposure region and the conductive blade in the cleaning and charging position P1, and thus, the non-exposure region enters an overcharging state. In order to prevent this problem, it is preferable to install a neutralization unit between the transfer position P5 and the cleaning and charging position P1.

In addition, in this embodiment, the surface of the photosensitive body 2 is charged at a desired surface electric potential by means of two stages of charging processes, but, for example, a single stage of charging may be performed using only the conductive blade as in the apparatus in the reference JP-A-4-304476 (FIGS. 2 and 5). That is, the cleaning process and the charging of the surface of the photosensitive body 2 may be simultaneously completed in the cleaning and charging position P1, by applying an overlap bias to the conductive blade 4. In this case, it is not necessary to install the charger 5, thereby achieving a simplified and miniaturized apparatus.

Moreover, for example, the respective numerical values in the above described embodiment are only exemplary, and thus, the invention is not limited thereto. Further, in this embodiment, the negative charged toner is used, but the invention may be applied to an image forming apparatus which uses a positive charged toner. In this case, an electric potential relation of the respective units may be reversed to the above described embodiment.

Further, the image forming apparatus according to the embodiment exposes the surface of the photosensitive body 2 which is uniformly charged by the exposure unit 6 to form the electrostatic latent image, but may use any latent image forming unit other than the exposure unit as described above, as long as it is capable of forming the electrostatic latent image on the surface of the charged latent image carrier.

Moreover, in this embodiment, the number of the developing unit 7 is not particularly specified, but the invention is preferably applicable to a color image forming apparatus in which a plurality of developing units are installed in a rotary developing unit, a so-called tandem image forming apparatus in which the plurality of developing units are arranged around the intermediate transfer medium, or a black-and-white image forming apparatus in which a black-and-white image is formed by a single developing unit or the like.

The entire disclosure of Japanese Patent Application No. 2009-077269, filed Mar. 26, 2009 is expressly incorporated by reference herein.

What is claimed is:

1. An image forming apparatus comprising:
a latent image carrier which circumferentially rotates in a predetermined rotational direction;
a lubricant applying unit which applies a lubricant on a surface of the latent image carrier in a predetermined application position;
a developing unit which adheres a toner including an additive having an abrasion effect onto the surface of the latent image carrier on which the lubricant is applied to form a toner image, in a development position located on a downstream side of the application position in the rotational direction; and
a conductive blade which cleans and removes the toner on the surface of the latent image carrier by being in contact with the surface of the latent image carrier, and charges the surface of the latent image carrier, in a cleaning and charging position located on an upstream side of the development position in the rotational direction.

2. The image forming apparatus according to claim 1, wherein the cleaning and charging position is located on a downstream side of the application position in the rotational direction.

3. The image forming apparatus according to claim 1, further comprising a charger which charges the surface of the latent image carrier in a secondary charging position located on the upstream side of the development position, on a downstream side of the cleaning and charging position in the rotational direction,
wherein the conductive blade charges the surface of the latent image carrier at a first electric potential in the cleaning and charging position, and
wherein the charger charges the surface of the latent image carrier which is charged at the first electric potential, at a second electric potential.

4. The image forming apparatus according to claim 3, wherein the conductive blade charges the surface of the latent image carrier at the first electric potential having the same polarity as normal charged polarity of the toner according to application of a direct current voltage having the same polarity as the normal charged polarity of the toner; and
wherein the charger provides electric charges having reverse polarity to the normal charged polarity and adjusts an electric potential of the surface of the latent image carrier to the second electric potential.

5. The image forming apparatus according to claim 1, wherein the conductive blade charges the surface of the latent image carrier according to application of a bias generated by overlapping alternating voltage with direct current voltage having the same polarity as the normal charged polarity of the toner.

6. The image forming apparatus according to claim 1, wherein the additive having the abrasion effect is strontium titanate.

7. The image forming apparatus according to claim 1, wherein the toner includes an additive having a leak function.

8. The image forming apparatus according to claim 7, wherein the additive having the leak function includes titania, oxide semiconductor or an inorganic particulate which is coated with a semiconductive film on at least a portion of a surface thereof.

9. The image forming apparatus according to claim 1, wherein a volume average particle diameter of the toner is 5 μm or less, and a degree of circularity of the toner is 0.95 or more.

10. An image forming method comprising:
applying lubricant on a surface of a latent image carrier which circumferentially rotates in a predetermined rotational direction;
adhering a toner onto the surface of the latent image carrier on which an additive is applied to form a toner image; and
transferring the toner image onto a transfer medium; cleaning and removing remaining transfer toner which remains on the surface of the latent image carrier by bringing a conductive blade into contact with the surface of the latent image carrier, and charging the surface of the latent image carrier,
wherein a toner including an additive having an abrasion effect is used as the toner.
